(19) United States
(12) Patent Application Publication
(10) Pub. No.: US 2024/0273535 A1
(43) Pub. Date: Aug. 15, 2024

(54) COMPUTER MODELING FOR FRAUD DETECTION IN BLOCKCHAIN-BASED TRANSACTIONS

(71) Applicant: Stripe Inc., South San Francisco, CA (US)

(72) Inventors: Sen Forest Fang, South San Francisco, CA (US); Brendan Ryan, South San Francisco, CA (US)

(73) Assignee: Stripe Inc., South San Francisco, CA (US)

(21) Appl. No.: 18/108,385

(22) Filed: Feb. 10, 2023

(51) Int. Cl. G06Q 20/40; G06Q 20/36; G06Q 20/38

(52) U.S. Cl. CPC G06Q 20/4016; G06Q 20/36; G06Q 20/389

(57) ABSTRACT

Disclosed herein are systems and methods for identifying fraud in blockchain-based transactions. In one method, a server detects an interaction by a decentralized digital wallet with a first electronic transaction protocol corresponding to a blockchain; executes a computer model (previously trained based on characteristics of electronic transaction protocols corresponding to the blockchain and electronic transactions corresponding to electronic transaction protocols) to determine a risk score; and in response to determining that the risk score for the requested electronic transaction is above a threshold level, causing at least one graphical element of a GUI associated with the decentralized digital wallet to provide an indication of a risk associated with the requested electronic transaction.

### TECHNICAL FIELD

This application relates generally to generating, training, and operating computer models to analyze and detect fraud in blockchain-specific activity.

### BACKGROUND

As a result of distributed network technology's recent improvements, the use of virtual currency (e.g., blockchain-backed currency) to conduct transactions has become ubiquitous. As a result, many electronic payment applications support conducting transactions using different publicly available virtual currencies. For instance, users can now acquire virtual currency and use a platform provided by an electronic payment application to conduct transactions using virtual currency. In some cases, the virtual currency is owned and implemented by a third-party not related to the electronic payment application itself.

While this new paradigm of using third-party virtual currency on currency-agnostic platforms has many advantages, it also faces many technical shortcomings. For instance, unlike conventional-currency-based transactions, when facilitating a virtual-currency-based transaction, the electronic payment application may not have access to all the data needed to analyze the transaction. Bad actors have created a novel and sophisticated methods and systems to take advantage of this technical shortcoming that is specific to virtual currencies. Therefore, electronic payment systems and applications face technical challenges in protecting their users against fraud.

### SUMMARY

For the aforementioned reasons, there is a desire for methods and systems to identify fraud in a virtual-currency-backed transaction regardless of whether the virtual currency is owned (or otherwise functionally controlled) by an electronic payment application. There is a desire for computer models (e.g., trained via machine learning techniques) that can provide an efficient analysis of pertinent characteristics of a transaction request and provide rapid (real-time or near-real-time) results to users. Disclosed herein are methods and systems associated with an intelligent fraud detection system that uses machine-learning models to identify fraudulent activity. The intelligent fraud detection system disclosed herein can instruct a decentralized digital wallet to revise its user interface and/or its authorization protocol, such that the user is aware of the risks before conducting and/or approving a transaction.

In an embodiment, a method comprises in response to detecting, by risk detection module that is a communicatively coupled with a decentralized digital wallet, an interaction by the decentralized digital wallet with a first electronic transaction protocol corresponding to a blockchain: executing by the risk detection module, a computer model to determine a risk score for a requested electronic transaction corresponding to the interaction with the first electronic transaction protocol, wherein the computer model is previously trained based on one or more characteristics associated with one or more electronic transaction protocols corresponding to the blockchain, and a plurality of electronic transactions corresponding to the one or more electronic transaction protocols, wherein the one or more electronic transaction protocols includes the first electronic transaction protocol; and in response to determining that the risk score for the requested electronic transaction satisfies a threshold, causing, by a revision module, at least one graphical element of a graphical user interface (GUI) associated with the decentralized digital wallet to provide an indication of a risk associated with the requested electronic transaction.

In another embodiment, a system comprises a computer readable medium having a set of instructions, that when executed, cause a processor to: in response to detecting that is a communicatively coupled with a decentralized digital wallet, an interaction by the decentralized digital wallet with a first electronic transaction protocol corresponding to a blockchain: execute, by a risk detection module, a computer model to determine a risk score for a requested electronic transaction corresponding to the interaction with the first electronic transaction protocol, wherein the computer model is previously trained based on one or more characteristics associated with one or more electronic transaction protocols corresponding to the blockchain, and a plurality of electronic transactions corresponding to the one or more electronic transaction protocols, wherein the one or more electronic transaction protocols includes the first electronic transaction protocol; and in response to determining that the risk score for the requested electronic transaction satisfies a threshold, cause, by a revision module, at least one graphical element of a GUI associated with the decentralized digital wallet to provide an indication of a risk associated with the requested electronic transaction.

In another embodiment, a system comprises a server configured to in response to detecting that is a communicatively coupled with a decentralized digital wallet, an interaction by the decentralized digital wallet with a first electronic transaction protocol corresponding to a blockchain: execute, via a risk detection module, a computer model to determine a risk score for a requested electronic transaction corresponding to the interaction with the first electronic transaction protocol, wherein the computer model is previously trained based on one or more characteristics associated with one or more electronic transaction protocols corresponding to the blockchain, and a plurality of electronic transactions corresponding to the one or more electronic transaction protocols, wherein the one or more electronic transaction protocols includes the first electronic transaction protocol; and in response to determining that the risk score for the requested electronic transaction satisfies a threshold, cause, via a revision module, at least one graphical element of a GUI associated with the decentralized digital wallet to provide an indication of a risk associated with the requested electronic transaction.

### BRIEF DESCRIPTION OF THE DRAWINGS

Non-limiting embodiments of the present disclosure are described by way of example with reference to the accompanying figures, which are schematic and are not drawn to scale. Unless indicated as representing the background art, the figures represent aspects of the disclosure.

FIG. 1 illustrates various components of an intelligent fraud detection system, according to an embodiment.

FIG. 2 illustrates a flow diagram of a process executed in an intelligent fraud detection system, according to an embodiment.

FIGS. 3-7 illustrate various graphical user interfaces presented and/or revised by an intelligent fraud detection system, according to an embodiment.

FIG. 8 illustrates a flow diagram of a process executed in an intelligent fraud detection system, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein—and additional applications of the principles of the subject matter illustrated herein—that would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

As will be described below, a server (referred to herein as the analytics server) can be communicatively coupled with a digital wallet (sometimes refers to as a decentralized digital wallet) associated with a blockchain, such as the blockchain 150. The analytics server can then analyze data using various methods described herein to determine whether an electronic transaction protocol (e.g., a smart contract) is attempting to conduct a transaction within the underlying blockchain. If so, the analytics server may instruct the digital wallet to revise at least one graphical element, such that the user is aware of the risks before conducting/approving the transaction.

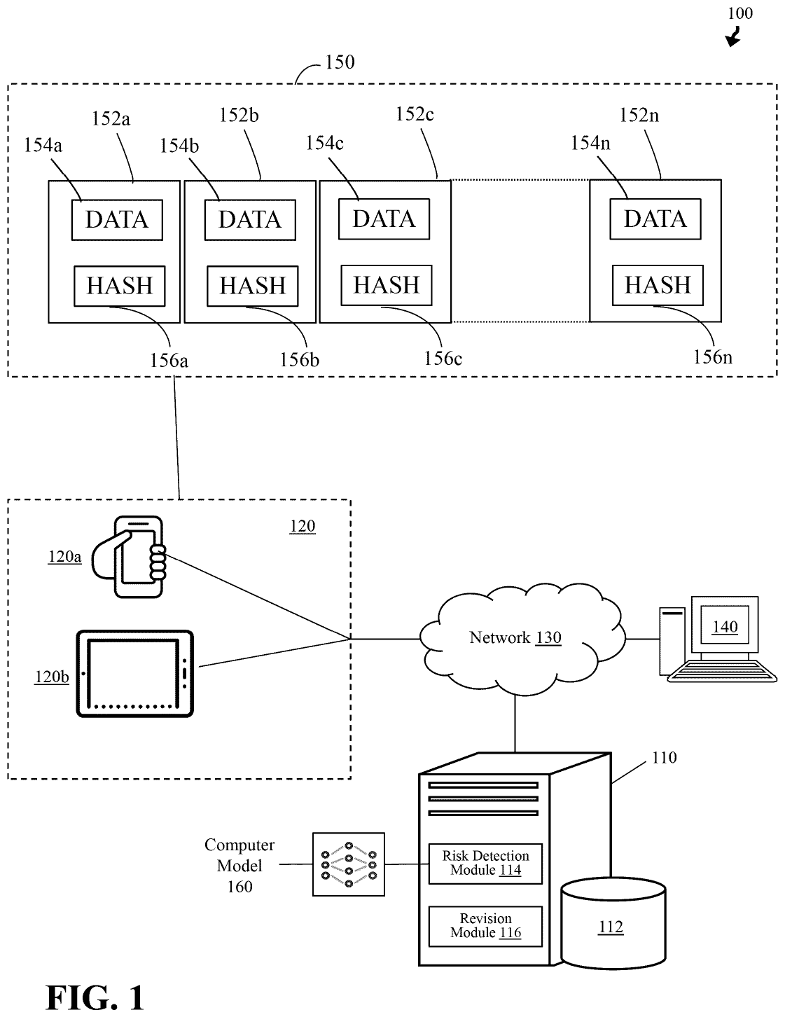

FIG. 1 is a non-limiting example of components of an intelligent fraud detection system 100 in which an analytics server 110 operates. The analytics server 110 may utilize features described in FIG. 1 to retrieve data and generate/display results, e.g., via a platform displayed on various devices. The analytics server 110 may be communicatively coupled to a system database 112, end-user devices 120a-b (collectively end-user devices 120), and an administrator computing device 140. The analytics server 110 may also use various computer models (e.g., computer model 160) to analyze the data.

The system 100 is not confined to the components described herein and may include additional or other components (not shown for brevity) that are to be considered within the scope of the embodiments described herein.

The above-mentioned components may be connected to each other through a network 130. The examples of the network 130 may include, but are not limited to, private or public LAN, WLAN, MAN, WAN, and the Internet. The network 130 may include both wired and wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and Institute of Electrical and Electronics Engineers (IEEE) communication protocols. In one example, the network 130 may include wireless communications according to Bluetooth specification sets or another standard or proprietary wireless communication protocol. In another example, the network 130 may also include communications over a cellular network, including, e.g., a GSM (Global System for Mobile Communications), CDMA (Code Division Multiple Access), and/or EDGE (Enhanced Data for Global Evolution) network.

The analytics server 110 may generate, display, and/or dynamically revise an electronic platform configured to output the results of analyzing the data retrieved. The electronic platform may include one or more graphical user interfaces (GUIs) displayed on any of the electronic devices in communication with the analytics server 110, such as the end-user devices 120 or the administrator computing device 140. An example of the platform generated and hosted by the analytics server 110 may be a web-based application or a website configured to be displayed on various electronic devices, such as mobile devices, tablets, personal computers, and the like. For example, the platform may be used to conduct transactions, such as making peer-to-peer payments or generating invoices. The platform may also be a GUI associated with a decentralized wallet in communication with one or more blockchains, such as a blockchain 150. A non-limiting example of the platform may include a payment application or an interface of a decentralized digital wallet of one or more end-users. The platform may not always be hosted by the analytics server 110. For instance, in some embodiments, a user interface of a decentralized digital wallet may be hosted (or otherwise functionally controlled) by a third-party server. Using the methods and systems discussed herein, the analytics server 110 may revise one or more graphical elements of the platform, regardless of whether the platform is hosted by the analytics server 110 or a third-party.

The blockchain 150 may be a public or private blockchain having multiple nodes. The blockchain 150 may include information needed to conduct transactions using cryptocurrency. For instance, the blockchain 150 may be a third-party blockchain supporting a publicly traded cryptocurrency. In some embodiments, the blockchain 150 may be a private blockchain used for transactions using a private cryptocurrency.

The blockchain 150 may comprise block instances 152a-152n (collectively 152). The block instances 152 may include data 154a-154n (collectively 154) that enables information, such data needed to conduct transactions using cryptocurrency, such as data associated with how many tokens each user owns, previous transactions, and the like. Also contained in the blockchain 150 may be hash values 156a-156n (collectively 156) that are used to link each of the block instances 152 to the preceding blockchain instances or blockchain formed by the preceding blockchain instances, as understood in the art.

The block instances 152 may be stored in different nodes, such as different computing devices associated with the blockchain 150. The analytics server 110 may be associated with one or more nodes of the blockchain 150. Alternatively, the analytics server 110 may not be a node (or be in communication with a node) of the blockchain 150.

The blockchain 150 may be utilized, via the decentralized digital wallet of an end-user operating the end-user devices 120, to conduct transactions. For instance, a decentralized digital wallet of an end-user may be in communication with the blockchain 150 (e.g., be a node within the blockchain 150). In those embodiments, the end-user may instruct the decentralized digital wallet to perform various actions (e.g., send a payment using cryptocurrency). The decentralized digital wallet (in conjunction with various servers) may facilitate the transaction, whereby data generated may be written on the blockchain 150 as a block instance.

The analytics server 110 may or may not be a part of the blockchain 150. Specifically, the analytics server 110 (or another computing feature in communication with the analytics server 110) may be a node within the blockchain 150. Alternatively, the analytics server 110 may not be a node and may not have access to the data included within the blockchain 150 (other than via the end-user's decentralized digital wallet).

The analytics server 110 may be any computing device comprising a processor and non-transitory, machine-readable storage capable of executing the various tasks and processes described herein. The analytics server 110 may employ various processors such as a central processing unit (CPU) and graphics processing unit (GPU), among others. Non-limiting examples of such computing devices may include workstation computers, laptop computers, server computers, and the like. While the system 100 includes a single analytics server 110, the analytics server 110 may include any number of computing devices operating in a distributed computing environment, such as a cloud environment.

The administrator computing device 140 may represent a computing device operated by a system administrator. The administrator computing device 140 may be configured to display attributes generated by the analytics server 110 (e.g., various analytic metrics determined as a result of analyzing a transaction or data generated during training/execution of the computer model 160); monitor the computer model 160 utilized by the analytics server 110, review feedback; and/or facilitate training or retraining (calibration) of the computer model 160 that are maintained by the analytics server 110.

In a non-limiting example, an administrator may access the platform hosted by the analytics server 110 to access alerts generated by the analytics server 110. The alerts may identify one or more fraudulent transactions or transactions that are predicted to be fraudulent. The administrator may review the alerts and indicate whether they are true positive alerts or false positive alerts. The analytics server 110 may monitor the administrator's activity and interactions with the alerts. If the analytics server 110 determines that the administrator has indicated a false positive, the analytics server 110 may recalibrate the computer model 160 accordingly. Thereby, the analytics server 110 may generate a feedback loop where the data is periodically used to improve the system and retrain the computer model 160.

The analytics server 110 may execute the computer model 160 to analyze the data to predict a score indicating a likelihood of a transaction (or an account) being fraudulent. Additionally, the analytics server 110 may train the computer model 160 using a training dataset generated based on monitoring data associated with an electronic payment system.

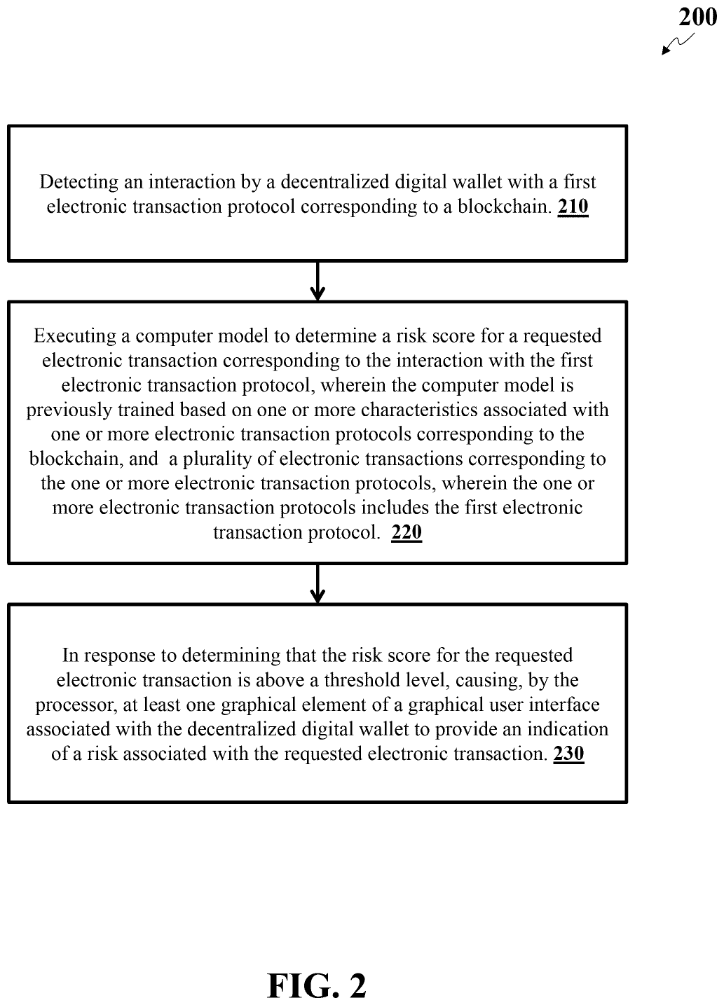

FIG. 2 illustrates a flow diagram of a process executed in an intelligent fraud detection system 100, according to an embodiment. The method 200 includes steps 210-230. Various embodiments may include additional or alternative execution steps, or may omit one or more steps altogether. The method 200 is described as being executed by a server, similar to the analytics server described in FIG. 1. However, one or more steps of method 200 may also be executed by any number of computing devices operating in the distributed computing system described in FIG. 1. For instance, one or more computing devices (e.g., end-user devices) may locally perform part or all of the steps described in FIG. 2.

Using the methods and systems described herein, such as the method 200, the analytics server may analyze a user's decentralized digital wallet, execute various analytical protocols, determine a likelihood of fraud for one or more transactions, and revise one or more graphical elements of the decentralized digital wallet associated with the user's cryptocurrency holdings.

At step 210, the analytics server may detect an interaction by a decentralized digital wallet with a first electronic transaction protocol corresponding to a blockchain. The analytics server may monitor activities associated with a user's decentralized digital wallet. As used herein, a decentralized digital wallet may refer to a virtual wallet that allows users to store, send, and receive digital (e.g., blockchain-based) currencies, such as bitcoin, or make electronic payments for goods and services using their mobile device or computer. Decentralized digital wallets typically use encryption and other security measures to protect the user's financial information and transactions.

As discussed herein, the analytics server may control a software (such as an add-on) that is coupled to a user's decentralized digital wallet and via the software, the analytics server may be able to utilize the software to monitor the decentralized wallet's activities or cause changes to portions of the interface of the decentralized digital wallet.

For instance, the decentralized digital wallet may include code capable of connecting to a protocol built on a blockchain. In that way, the decentralized digital wallet may initiate blockchain transactions which are then processed by validators/miners of the blockchain). Furthermore, the analytics server may control a software (such as an add-on) that is coupled to the the decentralized digital wallet, and via the software, the analytics server may be able to utilize the software to monitor the decentralized wallet's activities, and furthermore partially control or cause changes to portions of the interface of the decentralized digital wallet (explained in further detail below). In other words, the analytics server can vicariously monitor all activities associated with the decentralized digital wallet, and subsequently, the data monitored may be analyzed using the methods discussed herein to identify whether a transaction is risky.

Additionally or alternatively, another party (e.g., a node within the blockchain, a third party server/node or a decentralized party) may control the add-on and may provide the risk indicators. Therefore, the methods discussed herein can also be performed by any party to the blockchain as well. In some additional embodiments, a centralized entity (e.g., analytic server) may control the add-on and also the blockchain (if it is a private blockchain).

Additionally or alternatively, alternatively, the decentralized digital wallet and/or the blockchain itself may not be functionally controlled by the analytics server. Therefore, the decentralized digital wallet may belong to a third party. Using the methods and systems discussed herein, the analytics server may identify potential fraud regardless of whether the decentralized digital wallet belongs to the analytics server or a third-party server.

In order to allow the analytics server to perform the methods discussed herein, the analytics server may first need to be coupled to the decentralized digital wallet (or be provided with access to a user's decentralized digital wallet). If the analytics server is functionally controlling the decentralized digital wallet, the analytics server may already be able to review data associated with the underlying blockchain and determine any interactions between the wallet and any node within the blockchain. However, if the decentralized digital wallet is solely controlled by the user, an add-on or a client side software may be connected or coupled with the decentralized digital wallet, with the add-on or client side software further being in communication with the analytics server so interactions and relevant data associated with the decentralized digital wallet, the underlying blockchain, and any relevant electronic transaction protocols built on the underlying blockchain can be monitored and identified.

The decentralized digital wallet, as discussed herein, may include software code that monitors/stores users' payment information and data associated with the underlying blockchain, allowing users to conduct transactions and manage their digital block-chain based currency. Connecting a digital wallet to the analytics server may refer to authorizing the analytics server to access the code associated with the decentralized digital wallet. For instance, a user may provide authentication information of their decentralized digital wallet to the analytics server using an interface, such that the analytics server can access the code that can monitor/analyze data associated with the underlying blockchain.

By gaining access to the user's digital wallet, the analytics server may monitor data associated with the underlying blockchain. Specifically, the analytics server may identify any interactions associated with the wallet itself (in real-time or near real-time). Among other things, in a non-limiting example of identifying an interaction, the analytics server may determine that one or more electronic transaction protocols are being or have been executed in relation to the blockchain. An electronic transaction protocol is a protocol that is (sometimes automatically) executed in relation to the blockchain. An example of an electronic transaction protocol is a smart contract.

The analytics server may determine that an electronic transaction protocol has been executed in relation to a blockchain by searching for a record of the execution on the blockchain itself. When an electronic transaction protocol is executed, the results of the execution (such as the transfer of funds or the updating of a database) may be recorded on the blockchain as a new transaction (e.g., within a new block instance). This transaction may then be validated and added to the blockchain by the network's consensus mechanism. To check if an electronic transaction protocol has been executed, the analytics server can search the blockchain for a transaction that is associated with the electronic transaction protocol. The analytics server may use the contract's unique identifier or “hash” to locate the contract on the blockchain and find any related transactions.

The analytics server may monitor the decentralized digital wallet and/or various accounts associated with the decentralized digital wallet to determine whether any funds are being withdrawn. Additionally or alternatively, the analytics server may query different nodes directly or use an application programming interface (API) to access information about the electronic transaction protocol.

Upon determining that an electronic transaction protocol is attempting to execute code in relation to the blockchain or has executed code in relation to the blockchain, the analytics server may retrieve data associated with the electronic transaction protocol and/or the (attempted) transaction itself.

An electronic transaction protocol, as used herein, may refer to a self-executing protocol (e.g., contract or smart contract) with the terms of the agreement between parties to the protocol (e.g., nodes within the blockchain) can be identified within the code of the electronic transaction protocol. The code and the agreements contained therein may be stored and replicated on the blockchain itself. Electronic transaction protocols may allow for the automation of code execution and enforcement, as the terms of the transaction are automatically carried out when certain conditions are met. Because electronic transaction protocols are stored on a blockchain, they are sometimes assumed to be transparent, immutable, and secure.

A non-limiting example of an electronic transaction protocol may be code associated with a payment or a financial transaction that can be used to (sometimes automatically) conduct a transaction, such as withdrawing money from an account associated with a decentralized digital wallet. For instance, an electronic transaction protocol may indicate that a certain amount of virtual currency will be deducted from an account associated with a user's wallet when a certain threshold is met, such as when a time threshold is satisfied (e.g., first of the month) or when the user performs an action (e.g., virtual currency is deducted from a user's wallet when the user watches a movie).

In some embodiments, the analytics server can identify data associated with the electronic transaction protocol by searching for a unique identifier or “hash” of the electronic transaction protocol on the blockchain itself. The hash, as used herein, may refer to a string of characters that is created using a cryptographic function and is unique to each electronic transaction protocol. The hash of an electronic transaction protocol may serve as a “fingerprint” for the electronic transaction protocol and can be used to identify and locate the electronic transaction protocol on the blockchain. When an electronic transaction protocol is created, it may be added to the blockchain and its hash is recorded on the network. Any data associated with the electronic transaction protocol, such as transactions or other information, may also be recorded on the blockchain and linked to the electronic transaction protocol using the hash. To access this data, a server can search for the electronic transaction protocol hash on the blockchain and retrieve the associated data.

In addition to the hash, some electronic transaction protocols may also have other identifying information, such as a name or description, which can be used to locate them on the blockchain. For instance, an electronic transaction protocol may indicate the name of the entity (or the blockchain node) that is a party to the transactions (e.g., the name of the entity withdrawing virtual currency using the electronic transaction protocol).

The analytics server may also identify code associated with the electronic transaction protocol. To access the code, the analytics server may connect to a network (of the blockchain) to retrieve the code. The code may be stored on the blockchain and may be accessed by any node on the network that has permission to do so. To access the code, the analytics server may employ one or more of the following methods:

In some embodiments, the analytics server may (directly or indirectly) join the network of the blockchain as a full node. The analytics server may join the network as a full node and download a copy of the blockchain, including the electronic transaction protocols that are stored on it. This allows the analytics server to access the code.

In some embodiments, the analytics server may connect to an existing full node (e.g., the end-user's node). The analytics server may connect to an existing full node on the blockchain network and request access to the code. The full node can then retrieve the code from the blockchain and transmit the code back to the analytics server. Because the user is, in some embodiments, a node within the blockchain, the analytics server may use the user's computing device to retrieve the code.

In some embodiments, the analytics sever may employ an API. Many blockchain networks may provide APIs that allow different servers to access the blockchain and retrieve contract code without needing to connect to the network directly.

In some embodiments, the analytics server may retrieve the code from an external source (e.g., other than the blockchain). For instance, using an identifier of the electronic transaction protocol, the analytics server may query one or more databases (whether public or private) to identify code associated with the electronic transaction protocol.

The analytics server may also retrieve other data associated with the electronic transaction protocol, such as a timestamp of the transaction, parties to the transaction, IP address associated with any parties to the transaction, amount of transaction, and the like.

At step 220, the analytics server may execute a computer model to determine a risk score for a requested electronic transaction corresponding to the interaction with the first electronic transaction protocol, wherein the computer model is previously trained based on one or more characteristics associated with one or more electronic transaction protocols corresponding to the blockchain, and a plurality of electronic transactions corresponding to the one or more electronic transaction protocols, wherein the one or more electronic transaction protocols includes the first electronic transaction protocol.

Furthermore, in one or more embodiments, the interaction with the first electronic transaction protocol may be an attempt to connect to the protocol, an attempt to provide the protocol with access to the decentralized digital wallet (such as funds present in the decentralized digital wallet), an attempt to perform a transaction with one or more smart contracts associated with the electronic transaction protocol, or any other type of interaction between the decentralized digital wallet and the electronic transaction protocol.

In some embodiments, the analytics server may execute a computer model to identify a risk score associated with the transaction identified in the step 210. The computer model may be a machine-learning model that has been trained using a training dataset comprising characteristics associated with one or more electronic transaction protocols corresponding to the blockchain, and a plurality of electronic transactions corresponding to the one or more electronic transaction protocols, wherein the one or more electronic transaction protocols includes the first electronic transaction protocol.

Before implementing the computer model, the analytics server may first generate a training dataset that includes information associated with various previously-implemented transactions, different electronic transaction protocols, and the like. For instance, the training dataset may include code associated with different electronic transaction protocols.

The analytics server may train the computer model using various machine-learning algorithms (e.g., supervised, semi-supervised, or unsupervised). After the computer is trained, the computer model may be configured to receive data associated with a requested transaction and/or the electronic transaction protocol itself, such as its code.

The training dataset may include all the information needed for a machine learning model to predict the likelihood of fraud for a requested transaction associated with an electronic transaction protocol. The training dataset may include several types of data. The analytics server may include transaction data within the training data. Transaction data, as used herein, may include any data associated with previously conducted transactions (whether implemented by a user in a P2P transaction or implemented using an automated electronic transaction protocol). This would include information such as the transaction amount, the addresses (physical or IP) involved in the transaction, the time and date of the transaction, and any other relevant details.

The transaction data may be analyzed by the computer model to understand the context of the requested transaction and the context of known fraudulent and appropriate transactions. For instance, during training, the computer model may identify hidden patterns indicating a relationship between the transaction data and whether the underlying transaction is fraudulent (or risky).

The training dataset may also include data on historical fraud patterns to learn/recognize patterns associated with fraudulent transactions. This would include information such as the addresses or transaction types that have been identified as being involved in past fraudulent activity, as well as the outcomes of past fraudulent transactions.

The training dataset may also include data associated with the electronic transaction protocol's code and execution to understand how the electronic transaction protocol operates and to identify any potential vulnerabilities that could be exploited for fraudulent activity. This would include information on the protocol's code, its deployment on the blockchain, and any changes or updates made to the protocol over time.

The training dataset may also include data associated with the reputation of the parties involved in the transaction. This may include data from internal and external sources such as social media, news articles and the like, which can give a sense of the parties' reputation in the market. For instance, in conjunction with the transaction data discussed herein, the reputation data may indicate that a party (e.g., a particular IP address) has been involved in a few transactions that were later identified as fraudulent.

The analytics server may pre-process the data included within the training dataset. As a result, the training data may be preprocessed and transformed into a format that can be used to train a machine learning model. In some configurations, the analytics server may label the data points within the training dataset. For instance, the data corresponding to a particular transaction may be labeled as “fraud” or “not fraud” so the model can learn to predict the likelihood of fraud based on the provided dataset. When processed and labeled, the training dataset may be large enough to train the model to make accurate predictions and diverse enough to cover different scenarios and variations. Pre-processing the data may also include cleaning, normalizing, and/or transforming it into a format that can be used for training the computer model.

After generating the training dataset, the analytics server may train the computer model using various machine-leaning approaches. The analytics server may use a supervised, unsupervised, semi-supervised, or a reinforcement learning method to train a computer model using the training dataset to predict a score indicative of the likelihood of fraud for a requested transaction (e.g., received via an electronic transaction protocol). The analytics server may train the model to learn patterns in the training dataset that are indicative of fraudulent activity and to produce a score that represents the likelihood of fraud for a given transaction.

The analytics server may evaluate the performance of the trained model using techniques such as cross-validation and testing to measure the model's accuracy, precision, and recall. Based on the results, the analytics server can adjust the model's parameters or retrain the model if necessary.

When training is finished and the model has an accuracy that satisfies a threshold, the trained model may be deployed (e.g., connected to a specified endpoint for use by other systems or applications). The trained computer model can be integrated into a smart contract or a transaction validation system to automatically score and flag potentially fraudulent transactions.

Even after implementing the trained computer model, the analytics server may continuously monitor the performance of the deployed model and updates it with new data as it becomes available. This allows the model to improve over time and adapt to changing fraud patterns. For instance, if a transaction flagged as risky is overwritten (by the end-user or a system administrator).

The score, as used herein, may refer to a likelihood that a transaction or other interaction/activities requested to be executed (or already executed) is associated with fraud. In addition to being predicted by the trained computer model, the score may also depend on one or more attributes of derived from the training dataset (e.g., historical data).

In predicting the score, the trained computer model may also consider the attributes of a party to the transaction. The trained computer model may have been trained using historical data where one or more attributes of an end-user (e.g. size of the company, type of transaction, and the like) may be considered when predicting a score. In some embodiments, a predetermined list of merchants or smart contracts may indicate that certain smart contracts have been identified as fraudulent. Therefore, the trained computer model may generate a high low score (indicating a very high risk of fraud) for transactions associated with those smart contracts.

Additionally or alternatively, in predicting the score, the trained computer model may use one or more of the categories of any of the attributes or data points within the training data. For instance, the computer model may evaluate a type of transaction being attempted/requested (e.g., different transaction types may have different risk thresholds), history of the transactions performed by the decentralized digital wallet (e.g., historically, the same electronic transaction protocol may be involved in other fraudulent transactions and/or historically, the wallet has had many attempted transactions requests associated with a particular IP address or at a particular time), history of transactions by all parties with the electronic transaction protocol, amount of the transaction or access, and current activity on the underlying blockchain or the protocol built on the blockchain (e.g., the computer model may evaluate whether there is a spike in activity currently occurring that could be an indicator of fraudulent activity).

The analytics server may keep (and periodically update) a list of fraudulent activities, fraudulent electronic transaction protocols, and their corresponding accounts/end-users. For instance, the analytics server may generate an identity graph corresponding to fraudulent activities and their associated data points. The identity graph may indicate a cluster of data points that have been associated with an entity and/or associated with known fraud cases and/or electronic transaction protocols.

At step 230 the analytics server may, in response to determining that the risk score for the requested electronic transaction is above a threshold level, cause at least one graphical element of a GUI associated with the decentralized digital wallet to provide an indication of a risk associated with the requested electronic transaction.

When a requested transaction has a score that satisfies a threshold (e.g., more than 70% or any other number identified by a system administrator and/or the user associated with the decentralized digital wallet), the analytics server may revise one or more graphical elements of the user's decentralized digital wallet. Revising a graphical element may refer to changing any attribute (e.g., visual attribute) of any of the graphical elements displayed in a user interface of the wallet including buttons, icons, layouts, images, icons, and the like, such as by changing a color, font, size, location or any other attribute of any element (or additionally may include making the user interface element greyed out, i.e., not able to be selected).

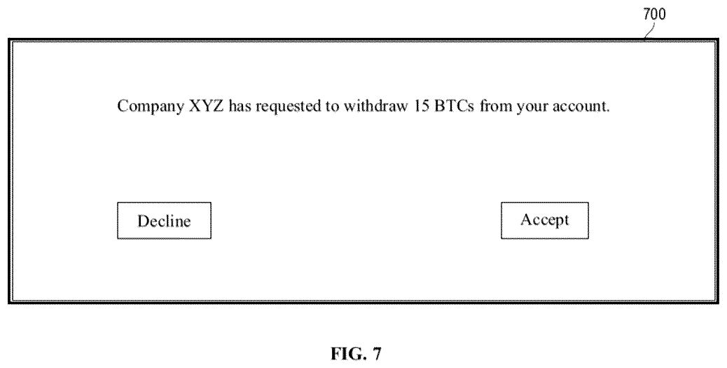

Additionally or alternatively, the analytics server may revise an authorization protocol needed to conduct the requested transaction. For instance, when the score satisfies the threshold (e.g., when the analytics server determines that the requested transaction is probably fraudulent), the analytics server may implement additional security measures, such as requesting an additional authentication (two-factor authentication) or transmitting push notifications to the user. An example of an additional notification to the user to receive the user's express authorization may include the interface depicted in FIG. 7. For instance, if a potential transaction has a high score and merits additional security, the analytics server may cause the wallet to initiate a multi-device authorization. As a result, the analytics server (either directly or via the wallet) presents the notification 700 on a user's device (e.g., cell phone) and only allows the transaction to be facilitated when the user has authorized the transaction (e.g., via the accept button).

The methods discussed herein may be described as being executed by the analytics server 110. However, the analytics server 110 may represent one or more processors that can perform the actions discussed herein. Therefore, the analytics server 110 may include one or more module where different actions are performed by different modules. For instance, a risk detection module 114 may be in communication with the digital wallet and may determine whether an interaction has occurred. The risk detection module 114 may also be in communication with the computer model 160. For instance, the risk detection module 114 may execute the computer model 160 and detect (using the predicted results) whether the interactions are risky (e.g., based upon whether a score of an interaction satisfies a threshold, as described herein). Additionally, the analytics server 110 may include a revision module 116, where the revision module 116 can revise a presentation of information in one or more GUIs, as discussed herein.

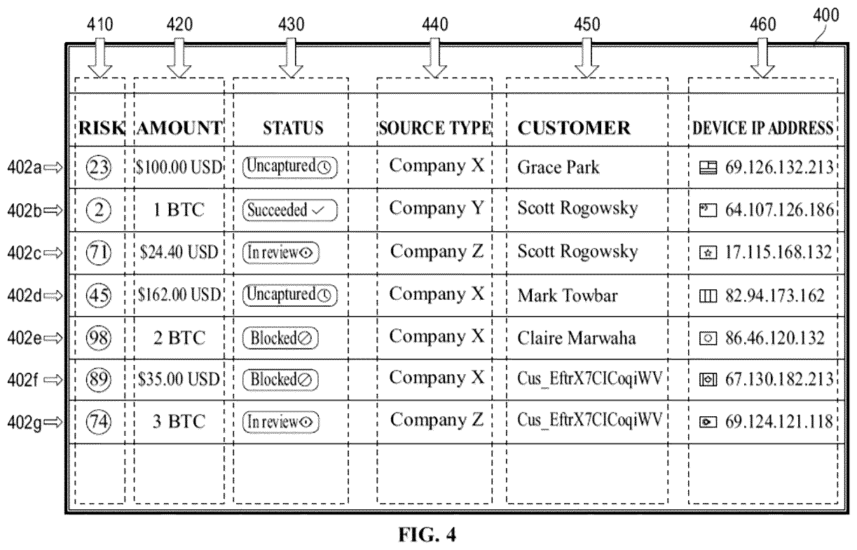

Referring back to FIG. 2, the analytics server may revise one or more attributes of a user interface associated with the decentralized digital wallet. In some embodiments, the analytics server may directly deny the transaction request. For instance, if the trained computer model determines that the likelihood of fraud is 97%, the analytics server may automatically suspend or deny the transaction, such that the transaction cannot be performed. The user, e.g., using a dashboard depicted in FIG. 4, can view a status of all activities associated with their decentralized digital wallet. In some embodiments, the user can retroactively override a decision by the analytics server to deny a transaction.

In some embodiments, the analytics server may monitor the user's activities and generate a user score accordingly. The user score may correspond to a particular user and/or the user's digital wallet. The user score may be a numerical rating that represents an individual's risk awareness, as determined by how risky a user's transactions are with respect to a particular decentralized digital wallet. The user score may be based on the risk analysis discussed herein (e.g., method 200) and how the user interacts with notifications generated by the analytics server. For instance, the user score may consider factors such as percentage of transactions that the system identified as risky, the percentage of failed transactions, percentage of acceptance (or overriding) of a notification that indicated a potential transaction as risky, payment history, outstanding debt, and credit utilization, and the like.

The analytics server may use the score to conduct transactions with the user. For instance, if a user applies for a loan, the user score may be used (in conjunction with other factors) to determine approval of the loan payment and/or interest rate. For instance, a higher user score may indicate a lower risk of default and may be associated with better interest rates and loan terms. A lower user score may indicate a higher risk of default and may be associated with less-favorable interest rates and loan terms. In a non-limiting example, the score may represent a proportion of the risky transactions conducted in relation to the total number of transactions. In some embodiments, the higher the proportion of risky transactions to the overall transactions conducted (e.g, 60% of the transactions conducted are risky), the lower the score may be. As a result, the user may receive less favorable terms (or may be denied all together).

In some embodiments, the user may be a merchant who connects their digital decentralized wallet to the analytics server. Using the methods and systems discussed herein, the analytics server may generate a score for the merchant that indicates how risky the merchant is. The score may then be used for various business purposes (e.g., originating loans, issuing credit, or providing temporary authorization for transactions).

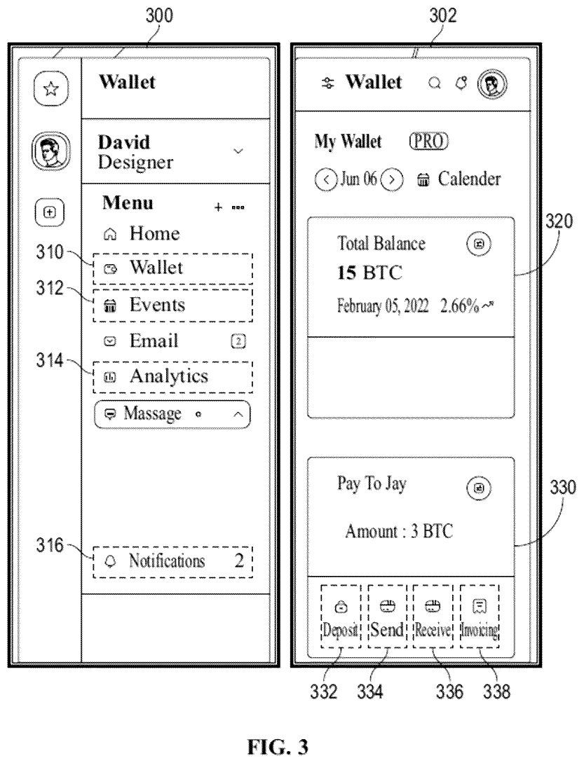

Referring now to FIG. 3, a GUI 300 may represent an interface of a payment application or a decentralized digital wallet of the end-user. The payment application be functionally associated with the analytics server (e.g., hosted directly by the analytics server or hosted by another server of the same institution as the analytics server). For instance, the payment application may belong to an electronic payment system that is associated with the analytics server. Alternatively, the payment application may be a third-party payment application.

The GUI 300 may include various graphical features directing the user to different GUIs/pages. As described herein, the analytics server may revise any of the graphical elements depicted in any of the GUIs depicted and/or discussed herein.

When the user interacts with the graphical indicator 310, the payment application may direct the user to a GUI 302. The GUI 302 may depict information associated with the user's decentralized digital wallet. The GUI 302 may depict a total balance (graphical element 320) or pending and/or completed transactions. The GUI 302 may also include interactive elements 332, 334, 336, and 338 allowing the user to deposit cryptocurrency, send cryptocurrency to another user, receive (e.g., request) cryptocurrency from another user, and generate an invoice respectively. For instance, the user may use the interactive element 334 to send 3 BTCs to Jay, as depicted in the graphical element 330.

When a possible fraud is identified, the analytics server may change the color (or any other visual attribute) of the elements depicted in FIG. 3. For instance, the interactive element 336 may be red to indicate a possible fraud. In another embodiment, the element 334 may be deactivated (greyed out), such that the user cannot interact with it. In some embodiment, one or more graphical elements of the digital wallet may be deactivated (e.g., greyed out) until the end-user acknowledges that the transaction has been flagged as potentially risky (e.g., overrides the risk). For instance, one or more graphical elements may be greyed out as a result of identifying a risky (pending) transaction. When the end-user hovers over the greyed out graphical element, a pop up window may display information indicating that the transaction is potentially risky. The notification may also indicate reasons why the transaction has been identified as risky, such as indicating that the electronic transaction protocol has been involved in multiple other fraudulent activities, and the like. The notification may also allow the end-user to acknowledge the risk (e.g., via an input element). When the end-user acknowledges the risk, the graphical element may revert back and become activated again.

When the user interacts with the graphical indicator 314, the payment application may direct the user to the GUI 400, depicted in FIG. 4. The GUI 400 may depict a list of transactions conducted via the payment application or via the decentralized digital wallet associated with the GUI 302.

The GUI 400 may include a list of transactions (transactions 402a-g) associated with the user's wallet. The transaction list can be filtered and customized, such that the list corresponds to various attributes inputted by the user (e.g., filtered based on any attribute, such as time). Each transaction may be represented in a row having multiple columns. Each column may indicate an attribute associated with each transaction. For instance, a column 410 may indicate a risk score associated with the transaction; a column 420 may indicate an amount (whether in fiat currency or virtual currency), a column 430 may indicate the status of the transaction. The analytics server may take an action based on the score associated with each transaction. For instance, a transaction 402b has a low score. Therefore, the analytics server facilitates the transaction and the column 430 indicates it as a successful transaction. In another example, a transaction 402e is blocked. In another example, transaction 402g may be indicated as potentially fraudulent and “in review” (e.g., additional authorization may be required before the transaction is conducted).

A column 440 depicts a source type associated with the transaction, such as a party requesting the transactions; an optional column 450 may indicate a customer name associated with the transaction (e.g., for merchants); and a column 460 may indicate an IP address associated with each transaction.

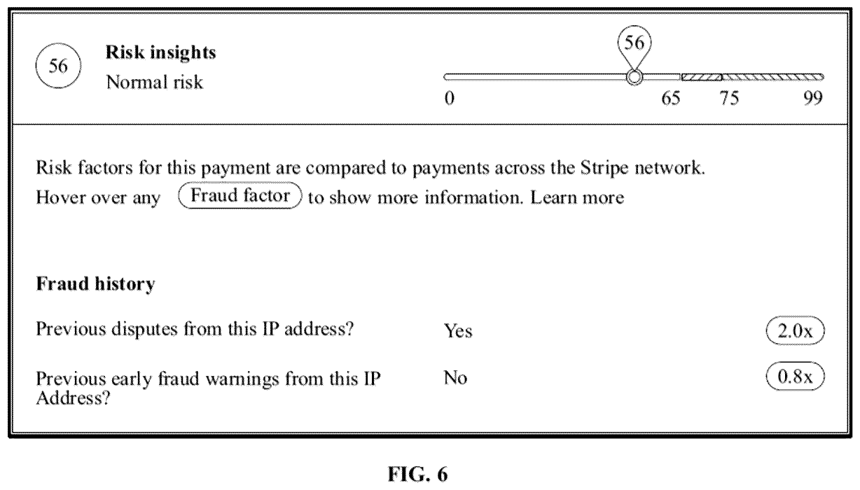

When a user interacts with a risk score depicted in the GUI 400, the analytics server may direct the user to a GUI depicted in FIG. 6 in which more information regarding the risk score (more insights) are provided.

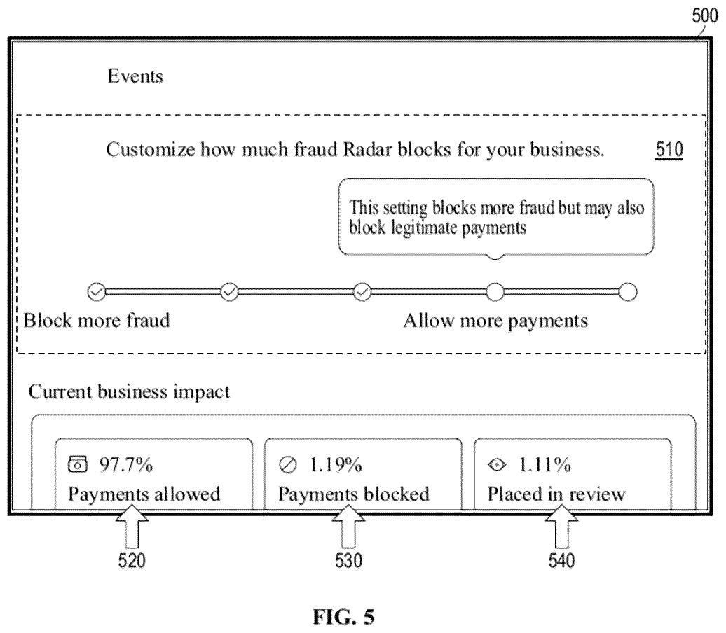

Referring back to FIG. 3, when the user interacts with the graphical indicator 312, the payment application may direct the user to the GUI 500, depicted in FIG. 5. The GUI 500 may depict various events and overall statistics. For instance, the GUI 500 includes a graphical element 520 indicating an overall percentage of payments allowed, a graphical element 530 indicating a percentage of payments that were blocked, and a graphical element 540 indicating a percentage of payments in review.

The GUI 500 may also include a graphical element 510 having an input element (e.g., sliding scale) allowing the user to customize/revise model sensitivity. When a user indicates a more sensitive model, the analytics server may identify more transactions as possibly fraudulent. In contrast, a less sensitive model may identify fewer transactions as possibly fraudulent.

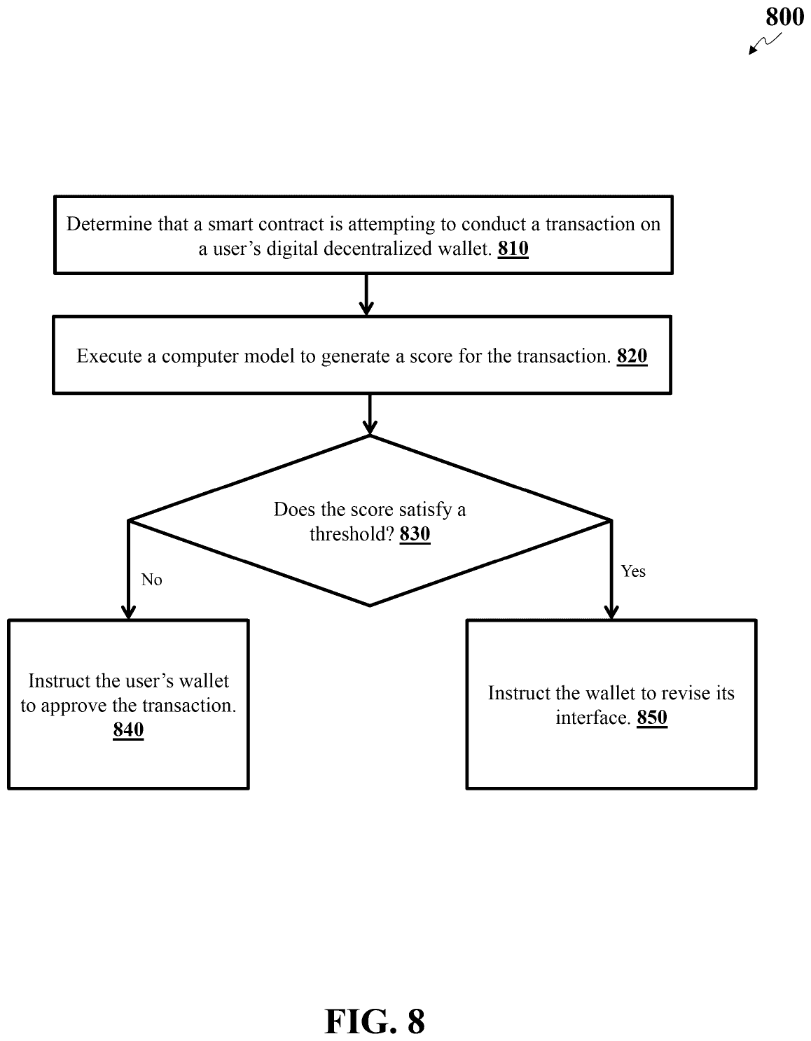

Referring now to FIG. 8, an example 800 depicts a non-limiting embodiment of implementation of the methods and systems discussed herein. At step 810, the analytics server may determine that a smart contract is attempting to conduct a transaction using a blockchain that is associated with a user's decentralized digital wallet. The analytics server may not be a node within the blockchain. However, the analytics server may be able to review activities via the user's digital wallet. For instance, by providing access (e.g., authentication) to the analytics server, the user may allow the analytics server to monitor activities associated with the underlying blockchain.

When the analytics server identifies a potential transaction by the smart contract, the analytics server retrieves data in associated with the transaction, such as name, code, and other information associated with the smart contract, name and other information associated with one or more parties to the transaction (e.g., owner of the smart contract), and data associated with the transaction (e.g., transaction amount, currency, and/or timestamp).

At step 820, using the retrieved information, the analytics server may execute a computer model to predict a score for the transaction. The computer model may be a model that has been trained using various methods discussed herein (e.g., method 200 described in FIG. 2). At step 830, the analytics server may determine whether the score satisfies a threshold. If the threshold is not met (the transaction has a risk that is lower than a predetermined amount), the analytics server may go to step 840 and instruct the digital wallet to conduct the transaction.

If, however, the score does satisfy the threshold, the analytics server may instruct the digital wallet to revise at least one of its graphical element, such as changing a color of an input element, deactivating an input element, and the like.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various components, blocks, modules, circuits, and steps have been generally described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory, computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A method comprising:
in response to detecting, by a risk detection module that is communicatively coupled with a decentralized digital wallet, an interaction by the decentralized digital wallet with a first electronic transaction protocol corresponding to a blockchain:
executing, by the risk detection module, a computer model to determine a risk score for a requested electronic transaction corresponding to the interaction with the first electronic transaction protocol, wherein the computer model is previously trained based on one or more characteristics associated with one or more electronic transaction protocols corresponding to the blockchain, and a plurality of electronic transactions corresponding to the one or more electronic transaction protocols, wherein the one or more electronic transaction protocols includes the first electronic transaction protocol; and
in response to determining that the risk score for the requested electronic transaction satisfies a threshold, causing, by a revision module, at least one graphical element of a graphical user interface associated with the decentralized digital wallet to provide an indication of a risk associated with the requested electronic transaction.

2. The method of claim 1, wherein causing the at least one graphical element to provide the indication of the risk corresponds to revising a visual attribute of the at least one graphical element.

3. The method of claim 1, wherein the at least one graphical element is displayed as a notification.

4. The method of claim 3, wherein the decentralized digital wallet causes the requested electronic transaction to be processed in response to receiving a positive response to the notification.

5. The method of claim 1, further comprising:
initiating, by the risk detection module, a new authentication method for the requested transaction.

6. The method of claim 1, further comprising:
generating, by the risk detection module, a score associated with the decentralized digital wallet, the score corresponding to a number of transactions associated with the decentralized digital wallet having a risk score that satisfies the threshold.

7. The method of claim 1, wherein causing the at least one graphical element to provide the indication of the risk corresponds to inactivating the at least one graphical element, such that a user associated with the decentralized digital wallet can no longer interact with the at least one graphical element.

8. A system comprising:
a computer readable medium having a set of instructions, that when executed, cause a processor to:
in response to detecting, via a risk detection module that is communicatively coupled with a decentralized digital wallet, an interaction by the decentralized digital wallet with a first electronic transaction protocol corresponding to a blockchain:
execute, via the risk detection module, a computer model to determine a risk score for a requested electronic transaction corresponding to the interaction with the first electronic transaction protocol, wherein the computer model is previously trained based on one or more characteristics associated with one or more electronic transaction protocols corresponding to the blockchain, and a plurality of electronic transactions corresponding to the one or more electronic transaction protocols, wherein the one or more electronic transaction protocols includes the first electronic transaction protocol; and
in response to determining that the risk score for the requested electronic transaction satisfies a threshold, cause, by a revision module, at least one graphical element of a graphical user interface associated with the decentralized digital wallet to provide an indication of a risk associated with the requested electronic transaction.

9. The system of claim 8, wherein causing the at least one graphical element to provide the indication of the risk corresponds to revising a visual attribute of the at least one graphical element.

10. The system of claim 8, wherein the at least one graphical element is displayed as a notification.

11. The system of claim 10, wherein the decentralized digital wallet causes the requested electronic transaction to be processed in response to receiving a positive response to the notification.

12. The system of claim 8, wherein the instructions further cause the processor to:
initiate a new authentication method for the requested transaction.

13. The system of claim 8, wherein the instructions further cause the processor to:
generate a score associated with the decentralized digital wallet, the score corresponding to a number of transactions associated with the decentralized digital wallet having a risk score that satisfies the threshold.

14. The system of claim 8, wherein causing the at least one graphical element to provide the indication of the risk corresponds to inactivating the at least one graphical element, such that a user associated with the decentralized digital wallet can no longer interact with the at least one graphical element.

15. A system comprising:
a server configured to:
in response to detecting, via a risk detection module that is a communicatively coupled with a decentralized digital wallet, an interaction by the decentralized digital wallet with a first electronic transaction protocol corresponding to a blockchain:
execute, via the risk detection module, a computer model to determine a risk score for a requested electronic transaction corresponding to the interaction with the first electronic transaction protocol, wherein the computer model is previously trained based on one or more characteristics associated with one or more electronic transaction protocols corresponding to the blockchain, and a plurality of electronic transactions corresponding to the one or more electronic transaction protocols, wherein the one or more electronic transaction protocols includes the first electronic transaction protocol; and
in response to determining that the risk score for the requested electronic transaction satisfies a threshold, cause, via a revision module, at least one graphical element of a graphical user interface associated with the decentralized digital wallet to provide an indication of a risk associated with the requested electronic transaction.

16. The system of claim 15, wherein causing the at least one graphical element to provide the indication of the risk corresponds to revising a visual attribute of the at least one graphical element.

17. The system of claim 15, wherein the at least one graphical element is displayed as notification.

18. The system of claim 17, wherein the decentralized digital wallet causes the requested electronic transaction to be processed in response to receiving a positive response to the notification.

19. The system of claim 15, wherein the server is further configured to:
initiate a new authentication method for the requested transaction.

20. The system of claim 15, wherein the server is further configured to:
generate a score associated with the decentralized digital wallet, the score corresponding to a number of transactions associated with the decentralized digital wallet having a risk score that satisfies the threshold.
